(19) United States
(12) Patent Application Publication
(10) Pub. No.: US 2024/0373514 A1
(43) Pub. Date: Nov. 7, 2024

(54) MICROHEATER AND GAS SENSOR

(71) Applicant: Niterra Co., Ltd., Nagoya-shi, Aichi (JP)

(72) Inventors: Yuto SHIMADA, Aichi (JP); Hiroaki YAGI, Aichi (JP); Takashi MORI, Aichi (JP); Takafumi SHICHIDA, Aichi (JP)

(21) Appl. No.: 18/291,610

(22) PCT Filed: Jul. 25, 2022
(86) PCT No.: PCT/JP2022/028580

§ 371 Date: Jan. 24, 2024

(30) Foreign Application Priority Data
Aug. 5, 2021 (JP) 2021-128791

(51) Int. Cl. H05B 3/26; G01N 25/18

(52) U.S. Cl. CPC H05B 3/26; G01N 25/18; H05B 2203/003; H05B 2203/013; H05B 2203/016; H05B 2203/017

(57) ABSTRACT

In a microheater 1 including: a substrate 10 provided with a through hole 11; a thin film 30 placed so as to close a front surface 10F side of the through hole 11 and forming a diaphragm DP; a heat generating resistor 50 placed in the thin film 30 and configured to generate heat when power is supplied thereto; and a first lead portion 70A and a second lead portion 70B placed in the thin film 30 and configured to supply power to the heat generating resistor 50, a front surface-side opening 11F which is an opening on the front surface 10F side of the through hole 11 has a circular shape, the heat generating resistor 50 is placed such that a first virtual line VC1 connecting an outer circumference thereof forms a circumference, and the first lead portion 70A and the second lead portion 70B connected to the heat generating resistor 50 are connected at a first connection portion 71A and a second connection portion 71B to the heat generating resistor 50. The second connection portion 71B is located on a side opposite to the first connection portion 71A with respect to a reference diameter line RL orthogonal to a first radius RA connecting the first connection portion 71A and a placement center O which is a center of the first virtual line VC1.

### TECHNICAL FIELD

The present disclosure relates to a microheater and a gas sensor.

### BACKGROUND ART

A gas sensor equipped a microheater that includes a substrate having a through hole, a thin film stretched in the through hole and forming a diaphragm, and a heat generating resistor provided on the thin film, has been known. In such a microheater, the following problems arise. If the heat distribution in the diaphragm is uneven when the resistor generates heat, the thin film may be damaged due to thermal stress caused by the temperature difference. In addition, if the diaphragm becomes locally hot when the resistor generates heat, the high-temperature portion deteriorates over time due to stress migration, resulting in a shorter product life.

For example, a gas sensor described in Patent Document 1 below includes a substrate having an opening (through hole) and made of silicon, a diaphragm covering the opening and composed of a multilayer insulating film, and a circular heater wired on the diaphragm. The heater is wired in a spiral shape, and the wiring width is adjusted in accordance with the distance from the center, thereby adjusting the amount of heat generated per unit area and improving the heat uniformity.

In the gas sensor, the opening has a quadrangular shape when the substrate is viewed in a plan view, and the distance from the center of the diaphragm to the opening edge of the substrate is not constant. Therefore, the heat conduction (heat dissipation) from the diaphragm to the substrate is not uniform, and the heat distribution may become uneven when the heater generates heat. In addition, since the opening edge includes a corner that is a singularity, stress acting on the multilayer insulating film which forms the diaphragm may be concentrated on a specific portion. Furthermore, since the outer shape of the spirally wired heater is strictly an elliptical shape, there is also a concern that anisotropy may occur in the heat distribution viewed from the center of the diaphragm.

### RELATED ART DOCUMENT

Patent Document 1: Japanese Patent No. 5436147

### Problem to be Solved by the Invention

In view of the above situation, an object of this technology is to provide a microheater and a gas sensor that reduce unevenness of a heat distribution and a stress distribution in a diaphragm and have excellent durability.

### DISCLOSURE OF THE PRESENT INVENTION

### Means for Solving the Problem

A microheater according to the present disclosure is a microheater including: a substrate provided with a through hole penetrating between a front surface and a back surface thereof; a thin film placed on the front surface so as to close the front surface side of the through hole and forming a diaphragm; a heat generating resistor placed in the thin film and configured to generate heat when power is supplied thereto; and a pair of lead portions placed in the thin film and configured to supply power to the heat generating resistor, wherein a front surface-side opening which is an opening on the front surface side of the through hole has a circular shape, the heat generating resistor is placed such that a first virtual line connecting an outer circumference of the heat generating resistor forms a circumference, the pair of lead portions include a first lead portion connected to a first connection portion provided at the heat generating resistor, and a second lead portion connected to a second connection portion provided at the heat generating resistor, and the second connection portion is located on a side opposite to the first connection portion with respect to a reference diameter line orthogonal to a first radius connecting the first connection portion and a placement center which is a center of the first virtual line.

### Advantageous Effect of the Invention

According to the present disclosure, it is possible to provide a microheater and a gas sensor that reduce unevenness of a heat distribution and a stress distribution in a diaphragm and have excellent durability.

### BRIEF DESCRIPTION OF THE DRAWINGS

FIG. 1 is a perspective view of a microheater according to an embodiment.

FIG. 2 is a plan view of the microheater according to the embodiment.

FIG. 3 is a schematic diagram showing a configuration of an A-A′ cross-section in FIG. 2.

FIG. 4 is an enlarged plan view of a placement portion of a heat generating resistor in FIG. 2.

FIG. 5 is a perspective view of a microheater according to a comparative example.

FIG. 6A is a temperature contour diagram showing the results of electricity-heat transfer simulation of the microheater according to the comparative example.

FIG. 6B is a temperature contour diagram showing the results of electricity-heat transfer simulation of a microheater according to an example.

FIG. 7 is a block diagram showing a schematic configuration of an example of a gas sensor including the microheater according to the embodiment.

### BEST MODE FOR CARRYING OUT THE INVENTION

### Description of Embodiments of the Present Disclosure

First, embodiments of the present disclosure are listed.

<1> The microheater of the present disclosure is a microheater including: a substrate provided with a through hole penetrating between a front surface and a back surface thereof; a thin film placed on the front surface so as to close the front surface side of the through hole and forming a diaphragm; a heat generating resistor placed in the thin film and configured to generate heat when power is supplied thereto; and a pair of lead portions placed in the thin film and configured to supply power to the heat generating resistor, wherein a front surface-side opening which is an opening on the front surface side of the through hole has a circular shape, the heat generating resistor is placed such that a first virtual line connecting an outer circumference of the heat generating resistor forms a circumference, the pair of lead portions include a first lead portion connected to a first connection portion provided at the heat generating resistor, and a second lead portion connected to a second connection portion provided at the heat generating resistor, and the second connection portion is located on a side opposite to the first connection portion with respect to a reference diameter line orthogonal to a first radius connecting the first connection portion and a placement center which is a center of the first virtual line.

<2> In the microheater according to <1> above, the first lead portion and the second lead portion are provided outside a placement region where the heat generating resistor is placed, so as to extend from the first connection portion and the second connection portion in opposite directions to each other.

<3> In the microheater according to <1> or <2> above, the placement center coincides with a center of the front surface-side opening when the substrate is viewed in a plan view.

<4> In the microheater according to any one of <1> to <3> above, the heat generating resistor is placed so as to form a continuous heater pattern connecting the first connection portion and the second connection portion with a single stroke, the pair of lead portions extend straight so as to be point-symmetrical to each other about the placement center, the heater pattern includes a linear center portion passing through the placement center along a direction in which the pair of lead portions extend, a plurality of arc-shaped portions extending on a plurality of virtual circumferences concentric with the first virtual line, and a straight portion connecting one end portion of one of the arc-shaped portions and one end portion of another of the arc-shaped portions in a straight manner, the first connection portion and the second connection portion are respectively provided at end portions of two outermost circumference semi-circular arc-shaped portions located on an outermost circumference and having a semi-circular arc shape among the plurality of arc-shaped portions, and the center portion is connected to end portions of two innermost circumference arc-shaped portions located at an innermost circumference among the plurality of arc-shaped portions.

<5> In the microheater according to <4> above, the heater pattern has a plurality of the straight portions, and includes a first pattern which forms one of the outermost circumference semi-circular arc-shaped portions along the first virtual line from the first connection portion, folds back via the straight portion before the second connection portion, forms the arc-shaped portion along the virtual circumference, and is connected to one end portion of the center portion on an extension line of the first lead portion, and a second pattern which forms another of the outermost circumference semi-circular arc-shaped portions along the first virtual line from the second connection portion, folds back via the straight portion before the first connection portion, forms the arc-shaped portion along the virtual circumference, and is connected to another end portion of the center portion on an extension line of the second lead portion.

<6> In the microheater according to <4> above, the heater pattern has a plurality of the straight portions, and includes a first pattern which forms one of the outermost circumference semi-circular arc-shaped portions along the first virtual line from the first connection portion, folds back via the straight portion before the second connection portion, forms the arc-shaped portion along the virtual circumference, folds back via the straight portion on an extension line of the first lead portion, and is then connected to one end portion of the center portion, and a second pattern which forms another of the outermost circumference semi-circular arc-shaped portions along the first virtual line from the second connection portion, folds back via the straight portion before the first connection portion, forms the arc-shaped portion along the virtual circumference, folds back via the straight portion on an extension line of the second lead portion, and is connected to another end portion of the center portion. In the above, the first pattern may be formed so as to be connected to the center portion via the innermost circumference arc-shaped portion after repeating, a predetermined number of times, folding back on the extension line of the first lead portion, then further forming the arc-shaped portion along the virtual circumference, and folding back before the extension line of the second lead portion or on the extension line of the first lead portion. The same applies to the second pattern.

<7> In the microheater according to any one of <4> to <6> above, the heater pattern is formed such that among the plurality of arc-shaped portions, the arc-shaped portion closer to the placement center has a larger wiring width.

<8> In the microheater according to any one of <4> to <6> above, each of a pair of second virtual lines obtained by extending the pair of lead portions, respectively, toward an inside of a placement region where the heat generating resistor is placed passes through the center portion.

<9> In the microheater according to any one of <4> to <8> above, the heater pattern is formed so as to be point-symmetrical about the placement center.

<10> A gas sensor including the microheater according to any one of <1> to <9> above.

### DETAILS OF EMBODIMENTS OF THE PRESENT DISCLOSURE

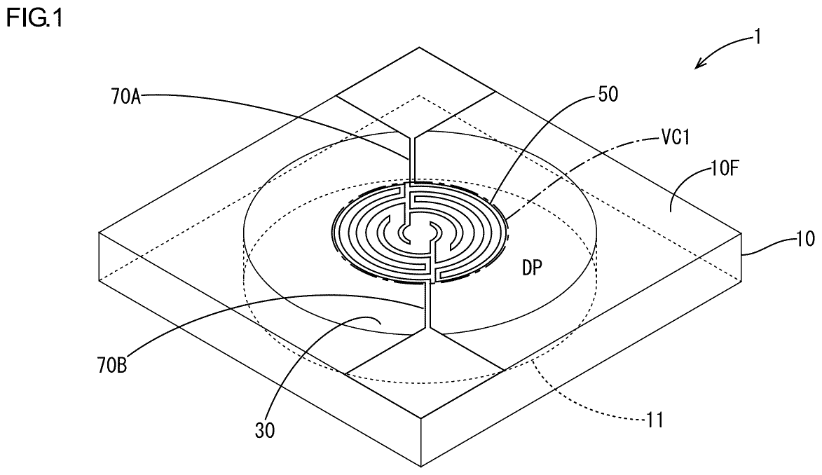

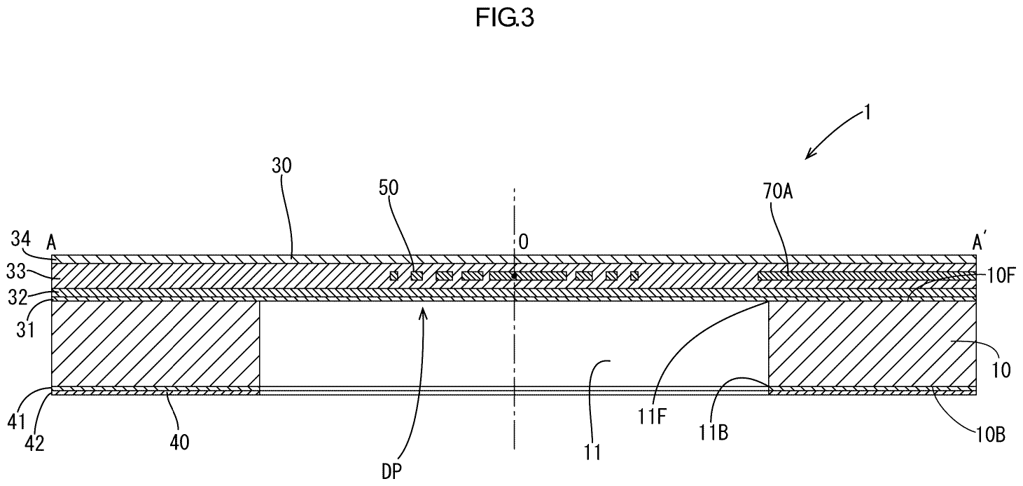

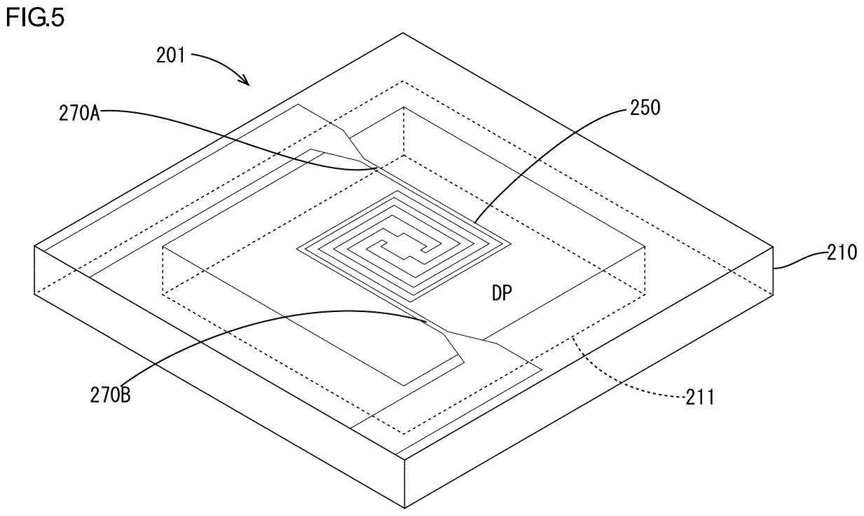

Specific examples of the microheater and the gas sensor of the present disclosure will be described with reference to the drawings below. The present disclosure is not limited to these examples, but is indicated by the claims, and is intended to include all modifications within the meaning and scope equivalent to the claims. In the following description, the near upper side of the drawing sheet of each of FIG. 1 and FIG. 5 and the upper side of FIG. 3 are referred to as upper side, but do not mean that the microheater is always used in such an orientation. In each drawing, for a plurality of identical members, one member may be designated by a reference symbol and reference symbols for the other members may be omitted. In addition, the relative sizes and placement of components in each drawing are not necessarily accurate, and the scale or the like of some components is changed for convenience of description. In the following description, “parallel” and “orthogonal” do not necessarily have to be strictly in such a positional relationship, but include “substantially parallel” and “substantially orthogonal” as long as there is no deviation from the gist of the present disclosure.

### <Microheater>

Hereinafter, a microheater 1 according to an embodiment will be described with reference to FIG. 1 to FIG. 5.

As shown in FIG. 1, the microheater 1 includes a substrate 10, a thin film 30 provided on a front surface 10F of the substrate 10 and forming a diaphragm DP, a heat generating resistor 50 provided in the thin film 30, and a pair of lead portions 70A and 70B provided in the thin film 30 and configured to supply power to the heat generating resistor 50.

### (Substrate)

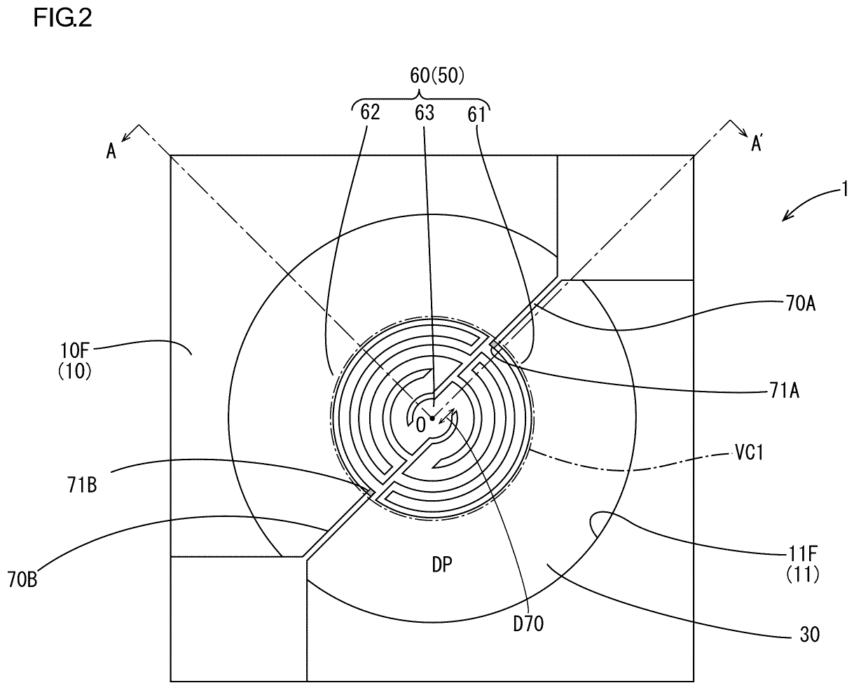

The substrate 10 is made of an insulating material, and, for example, a substrate made of silicon can be used. The outer shape of the substrate 10 is not limited, but can be formed, for example, as a square flat plate shape in a plan view as shown in FIG. 1 to FIG. 3. As shown in a plan view of FIG. 2, in the present embodiment, the substrate 10 having a square shape in a plan view will be described.

As shown in FIG. 3, etc., a cylindrical through hole 11 is formed in a central portion of the substrate 10 so as to penetrate between the front surface 10F which is the upper surface of the substrate 10 and a back surface 10B which is the lower surface of the substrate 10. As shown in FIG. 2, in the present embodiment, the substrate 10, in which the through hole 11 having, in the front surface 10F, a front surface-side opening 11F having a perfectly circular shape is formed, will be described. The front surface-side opening 11F is formed so as to be centered on the point of intersection of the diagonal lines of the front surface 10F which has a square shape, and the center of the front surface-side opening 11F coincides with a placement center O, which will be described later, when the substrate 10 is viewed in a plan view. As shown in FIG. 3, in the present embodiment, the through hole 11 is formed so as to extend straight through the substrate 10 in the up-down direction, and a back surface-side opening 11B in the back surface 10B is also formed in the same position and shape as the front surface-side opening 11F in the front surface 10F, but the through hole 11 is not limited to such a configuration. The through hole 11 may be formed, for example, such that the diameter thereof increases or decreases from the front surface-side opening 11F toward the back surface-side opening 11B.

### (Thin Film)

As shown in FIG. 3, etc., the thin film 30 is provided on the front surface 10F of the substrate 10 so as to close the front surface 10F side of the through hole 11, in other words, so as to cover the front surface-side opening 11F. The portion, of the thin film 30, corresponding to the front surface-side opening 11F forms the diaphragm DP. Therefore, the diaphragm DP has a circular shape centered on the placement center 0. In the present embodiment, an insulating back surface film 40 is also provided on the back surface 10B side of the substrate 10. An opening having the same shape and dimensions as the back surface-side opening 11B is provided at a location, corresponding to the back surface-side opening 11B, in a central portion of the back surface film 40.

The thin film 30 includes an insulating layer made of, for example, silicon oxide or silicon nitride. The thin film 30 may be formed from a single material, or may be formed so as to include multiple layers made of different materials as shown in FIG. 3. As shown in FIG. 3, the thin film 30 according to the present embodiment is composed of a multilayer film in which a first insulating layer 31 made of silicon oxide (Si02), a second insulating layer 32 made of silicon nitride (Si3N4), a third insulating layer 33 made of silicon oxide or the like, and a fourth insulating layer 34 made of silicon nitride are sequentially stacked on the front surface 10F. By forming the thin film 30 as a multilayer film as described above, sufficient insulation performance can be ensured while damage to the thin film 30 is reduced, thereby enhancing device reliability. As shown in FIG. 3, in the present embodiment, the back surface film 40 is also formed as a multilayer film in which a first back surface insulating layer 41 made of silicon oxide and a second back surface insulating layer 42 made of silicon nitride are sequentially stacked in this order from the side in contact with the back surface 10B. The above is an example of the configuration of the thin film 30 and the back surface film 40, and the thin film 30 and the back surface film 40 are not limited to such a configuration.

### (Heat Generating Resistor)

As shown in FIG. 1, FIG. 3, etc., the conductive heat generating resistor 50 is placed in the thin film 30. As shown in FIG. 3, the heat generating resistor 50 according to the present embodiment is placed inside the third insulating layer 33 which forms an intermediate layer of the thin film 30. The heat generating resistor 50 is preferably formed, for example, from a material containing a metal having a high thermal conductivity, such as platinum, gold, aluminum, and copper, and is formed from platinum in the present embodiment. The heat generating resistor 50 generates heat to heat the diaphragm DP, which is made of the thin film 30, when power is supplied thereto, and the resistance value thereof changes as the temperature thereof changes. As shown in FIG. 2, when the substrate 10 is viewed in a plan view, that is, viewed in the normal direction of the front surface 10F, the heat generating resistor 50 is placed such that a first virtual line VC1 connecting the outer circumference of the heat generating resistor 50 forms the circumference of a perfect circle. In addition, as shown in FIG. 2 and FIG. 3, when the substrate 10 is viewed in a plan view, the center of the first virtual line VC1, that is, the placement center O which is the center of a placement region where the heat generating resistor 50 is placed, coincides with the center of the front surface-side opening 11F. The placement shape of the heat generating resistor 50, that is, the detailed shape of a heater pattern 60, will be described later.

### (Lead Portions)

As shown in FIG. 1, the pair of lead portions 70A and 70B which are composed of a first lead portion 70A and a second lead portion 70B are also placed in the thin film 30. As shown in FIG. 3, similar to the heat generating resistor 50, the lead portions 70A and 70B according to the present embodiment are placed inside the third insulating layer 33 which forms the intermediate layer of the thin film 30. The lead portions 70A and 70B are also formed, for example, from a material containing a metal such as platinum, gold, aluminum, and copper. Although not shown in the drawings, the first lead portion 70A is connected to an electrode connected to an external power supply, and the second lead portion 70B is connected to a ground electrode, for example, via contact holes or the like formed in the third insulating layer 33 and the fourth insulating layer 34, thereby allowing power to be supplied to the heat generating resistor 50. The electrodes can be formed, for example, from a material containing a metal such as platinum and gold.

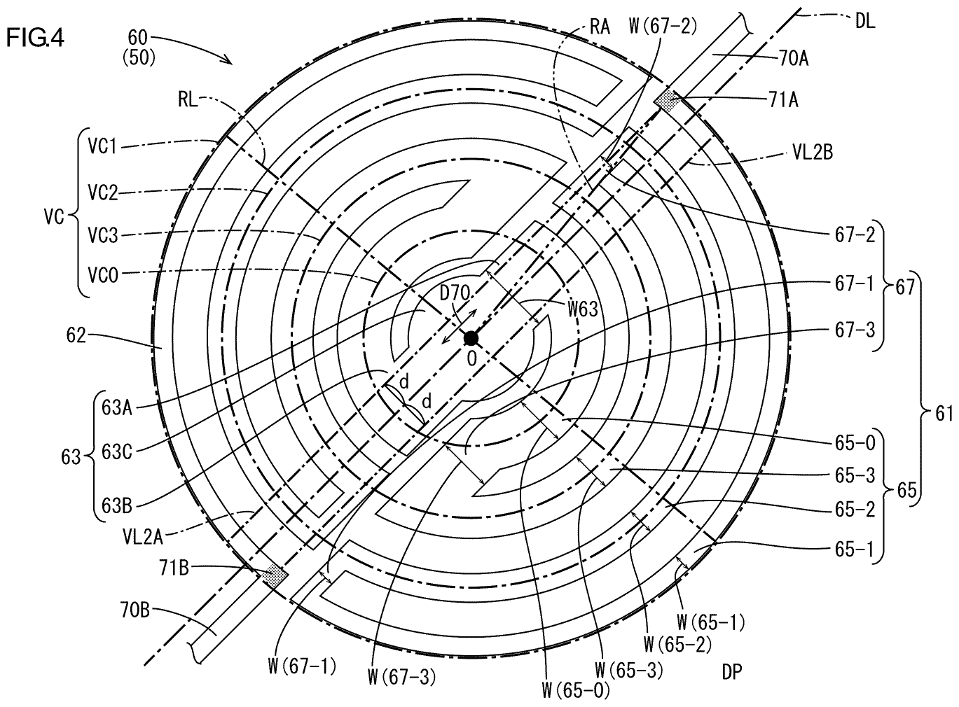

As shown in FIG. 2 and FIG. 4, the first lead portion 70A is connected to the heat generating resistor 50 at a first connection portion 71A which is provided at the outermost circumference of the heater pattern 60. In addition, the second lead portion 70B is connected to the heat generating resistor 50 at a second connection portion 71B which is similarly provided at the outermost circumference of the heater pattern 60. As shown in FIG. 4, the second connection portion 71B is located on the side opposite to the first connection portion 71A with respect to a reference diameter line RL orthogonal to a first radius RA connecting the placement center 0 and the first connection portion 71A. For example, in the heater pattern 60 shown in FIG. 4, while the first connection portion 71A is provided on the upper right side in FIG. 4, the second connection portion 71B is provided on the lower left side, and is located on the side opposite to the first connection portion 71A with respect to the reference diameter line RL extending from the upper left side to the lower right side.

As shown in FIG. 2, the first lead portion 70A and the second lead portion 70B are provided so as to extend from the first connection portion 71A and the second connection portion 71B, respectively, in opposite directions to each other toward the outside of the placement region of the heat generating resistor 50. In this specification, “extending in opposite directions” includes not only the case of both lead portions extending in strictly opposite directions, that is, extending strictly parallel, but also the case where both lead portions extend in substantially opposite directions. The pair of lead portions 70A and 70B according to the present embodiment extend straight on the square-shaped front surface 10F toward the vicinities of opposing corners (corners located on the upper right side and the lower left side in FIG. 2). In the present embodiment, as shown in FIG. 4, the first lead portion 70A and the second lead portion 70B are placed in positions and shapes that are point-symmetrical about the placement center 0. That is, the first lead portion 70A and the second lead portion 70B extend parallel to each other, and as shown in FIG. 4, a second virtual line VL2A obtained by extending the first lead portion 70A toward the inside of the placement region and a second virtual line VL2B obtained by extending the second lead portion 70B toward the inside of the placement region are parallel to each other. Also, in the present embodiment, a direction D70 in which the first lead portion 70A and the second lead portion extend is parallel to one diagonal line (diagonal line connecting the upper right corner and the lower left corner in FIG. 2) DL of the front surface 10F, and as shown in FIG. 4, an interval d between the diagonal line DL and the second virtual line VL2A and an interval d between the diagonal line DL and the second virtual line VL2B are equal to each other.

### (Heater Pattern)

The heat generating resistor 50 according to the present embodiment forms the continuous heater pattern 60 which connects the first connection portion 71A and the second connection portion 71B with a single stroke within the placement region having a perfectly circular shape as a whole. In the heater pattern 60, the heat generating resistor 50 is placed so as to be repeatedly folded back with approximately half circumference, thereby forming a plurality of concentric circle shapes. The detailed shape of the heater pattern 60 will be described below with reference to FIG. 2 and FIG. 4.

As shown in FIG. 4, the heater pattern 60 has a center portion 63 which extends along the direction D70, in which the lead portions 70A and 70B extend, and passes through the placement center O. In the present embodiment, since the lead portions 70A and 70B extend parallel to the diagonal line DL as described above, the center portion 63 which extends parallel to the direction D70 through the placement center O extends on the diagonal line DL as shown in FIG. 4. Both side edges, of the center portion 63, orthogonal to the direction in which the center portion 63 extends are formed so as to protrude toward the outer circumference side and form an arc centered on the placement center O. In other words, as shown in FIG. 4, the center portion 63 according to the present embodiment is formed by a circular center circle portion 63C centered on the placement center O and two protrusion portions 63A and 63B which protrude from the center circle portion 63C on the diagonal line DL and form both end portions of the center portion 63.

As shown in FIG. 2, etc., the heater pattern 60 also has a first pattern 61 connecting the first connection portion 71A and the center portion 63, and a second pattern 62 connecting the second connection portion 71B and the center portion 63. In the present embodiment, as shown in FIG. 4, etc., the first pattern 61 and the second pattern 62 have a point symmetrical shape with the placement center O as a center. Hereinafter, the first pattern 61 will be mainly described.

As shown in FIG. 4, the first pattern 61 has a plurality of arc-shaped portions 65 extending on a plurality of virtual circumferences VC concentric with the first virtual line VC1. In the following description, among the plurality of virtual circumferences VC including the first virtual line VC1, the virtual circumference located nth from the outer circumference side is denoted as a virtual circumference VCn (n is a positive integer), and the virtual circumference located on the innermost circumference side is denoted as an innermost virtual circumference VCO. In the present embodiment, the virtual circumference corresponding to a virtual circumference VC4 is the innermost virtual circumference VCO. In addition, in the following description, among the plurality of arc-shaped portions 65, the arc-shaped portion located nth from the outer circumference side is denoted as an arc-shaped portion 65-n (n is a positive integer), and the arc-shaped portion located on the innermost circumference side is denoted as an innermost circumference arc-shaped portion 65-0. In the present embodiment, the virtual circumference corresponding to an arc-shaped portion 65-4 is the innermost circumference arc-shaped portion 65-0. Among the plurality of arc-shaped portions, an outermost circumference semi-circular arc-shaped portion 65-1 is provided on the outermost circumference so as to be formed along the first virtual line VCI and have a semi-circular arc shape. In this specification, the “semi-circular arc shape” refers to an arc having a center angle of approximately 180°.Specifically, an arc “having a semi-circular arc shape” includes an arc whose center angle is not less than 170° and less than 180°, and more specifically, an arc whose center angle is not less than 175° and not greater than 178°.

As shown in FIG. 4, the first pattern 61 also has a straight portion 67 connecting one end portion of one arc-shaped portion 65 and one end portion of another arc-shaped portion 65. The first pattern 61 according to the present embodiment has a plurality of straight portions 67, and all of these straight portions 67 extend straight along the direction D70 in which the lead portions 70A and 70B extend. In the following description, among the plurality of straight portions 67 included in the first pattern 61, the straight portion 67 having the n-th smallest distance from the first virtual line VCI to a portion thereof that is closest to the first virtual line VC1 is denoted by 67-n (n is a positive integer).

As shown in FIG. 4, in the first pattern 61, one end portion of the outermost circumference semi-circular arc-shaped portion 65-1 is the first connection portion 71A, and the first lead portion 70A is connected thereto. In addition, one end portion of the innermost circumference arc-shaped portion 65-0 is connected to one end portion of the center portion 63 (one protrusion portion 63A). Similarly, in the second pattern 62, one end portion of the outermost circumference semi-circular arc-shaped portion 65-1 is the second connection portion 71B, and one end portion of the innermost circumference arc-shaped portion 65-O is connected to another end portion of the center portion 63 (other protrusion portion 63B). Accordingly, the first pattern 61 and the second pattern 62 are coupled to each other via the center portion 63, and the first lead portion 70A and the second lead portion 70B are electrically connected to each other.

As shown in FIG. 4, the first pattern 61 according to the present embodiment forms the outermost circumference semi-circular arc-shaped portion 65-1 along the first virtual line VC1 from the first connection portion 71A, folds back via a straight portion 67-1 before the second connection portion 71B, forms an arc-shaped portion 65-2 along a virtual circumference VC2, and is folded back via a straight portion 67-2 on the second virtual line VL2A which is an extension line of the first lead portion 70A. In the present embodiment, after being folded back via the straight portion 67-2, the first pattern 61 further forms an arc-shaped portion 65-3 along a virtual circumference VC3, is folded back via a straight portion 67-3 before the second virtual line VL2B which is an extension line of the second lead portion 70B, forms the innermost circumference arc-shaped portion 65-O along the innermost virtual circumference VCO, and is connected to the protrusion portion 63A on the second virtual line VL2A.

As shown in FIG. 4, in the above first pattern 61, a wiring width W65 of the plurality of arc-shaped portions 65 is formed such that the arc-shaped portion 65 located on the inner circumference side closer to the placement center O has a larger wiring width W65. Specifically, in the present embodiment, W(65-1)<W(65-2)<W(65-3)<W(65-O) is satisfied. In the present embodiment, a wiring width W67 of the plurality of straight portions 67 included in the first pattern 61 is also formed such that the straight portion 67 located on the inner circumference side closer to the placement center O has a larger wiring width W67. Specifically, W(67-1)<W(67-2)<W(67-3) is satisfied. In this specification, the “wiring width” refers to a width in a direction orthogonal to the direction in which the heater pattern forming a line extends.

Also, in the heater pattern 60, a wiring width W63 of the protrusion portions 63A and 63B of the center portion 63 (portions, of the center portion 63, having the smallest wiring width) satisfies W63≥W (67-3) for a wiring width W(67-3) of the straight portion 67-3 which is located on the innermost circumference side in the present embodiment. In addition, the pair of second virtual lines VL2A and VL2B obtained by extending the pair of lead portions 70A and 70B pass through the insides of the protrusion portions 63A and 63B of the center portion 63, respectively. In other words, the wiring width W63 of the protrusion portions 63A and 63B satisfies W63≥2d for an interval 2d between the second virtual lines VL2A and VL2B shown in FIG. 4.

### (Production Method for Microheater)

Hereinafter, an example of a production method for the microheater 1 described above will be described. First, a portion on the lower layer side of the thin film 30 is deposited on the front surface of a flat plate-shaped substrate having a square shape in a plan view, by a known method such as a reduced-pressure CVD method or plasma CVD. At this time, the back surface film 40 may be formed on the back surface in the same manner. Subsequently, conductive metal layers that form the lead portions 70A and 70B and the heat generating resistor 50 are patterned and formed on a part of the thin film 30 in the positions and shapes described above, by sputtering, etching, or the like. In the case of producing a gas detection element 170 described later, a temperature measuring resistor 150 may be formed at the same time as the heat generating resistor 50, etc. Then, the remaining portion on the upper layer side of the thin film 30 is formed on top of the patterned and formed metal layers by a CVD method or the like. Subsequently, contact holes are formed at appropriate locations in the respective layers of the thin film 30 by etching or the like. Thereafter, metal layers that form electrodes, etc., are patterned and formed by sputtering, etching, or the like to electrically connect the electrodes, etc., to the heat generating resistor 50. In the case of producing the gas detection element 170 having the temperature measuring 150, resistor electrodes for the temperature measuring resistor 150 may be formed at the same time and connected to the temperature measuring resistor 150. Subsequently, an opening is formed in the back surface film 40 by etching or the like, and the through hole 11 is provided in the substrate in the position and shape described above, and the diaphragm DP is formed. As described above, the microheater 1 shown in FIG. 1 can be produced.

### <Evaluation Experiment>

### (Example: Production of Microheater 1)

As a substrate, a flat plate-shaped silicon substrate having a square shape in a plan view as shown in FIG. 2 was prepared, and the thin film 30 composed of a multilayer film having the lead portions 70A and 70B and the heat generating resistor 50 therein as shown in FIG. 3 was formed on the front surface of the substrate. Specifically, first, the first insulating layer 31 made of silicon oxide and the second insulating layer 32 made of silicon nitride were sequentially stacked and formed on the front surface of the substrate by a CVD method, and the first back surface insulating layer 41 made of silicon oxide and the second back surface insulating layer 42 made of silicon nitride were stacked and formed on the back surface of the substrate to form the back surface film 40. Subsequently, on the second insulating layer 32, a portion on the lower layer side (second insulating layer 32 side) of the third insulating layer 33 made of silicon oxide or the like was formed by a CVD method, and then a platinum layer was patterned and formed by sputtering and etching, to form the lead portions 70A and 70B and the heat generating resistor 50 in the positions and shapes described above. On top of the patterned platinum layer, the remaining portion on the upper layer side of the third insulating layer 33 was formed by a CVD method or the like, and the fourth insulating layer 34 made of silicon nitride was further stacked and formed. Subsequently, contact holes were formed at appropriate locations in the respective layers of the thin film 30 by etching or the like, and layers made of gold were patterned and formed by sputtering and etching to form electrodes and electrically connect the heat generating resistor 50 thereto. Subsequently, an opening was formed in the back surface film 40 by etching, and the through hole 11 was provided in the substrate 10 in the position and shape described above, and the diaphragm DP was formed. The microheater 1 shown in FIG. 1 produced as described above was used as an evaluation sample of an example.

### (Comparative Example: Production of Microheater 201)

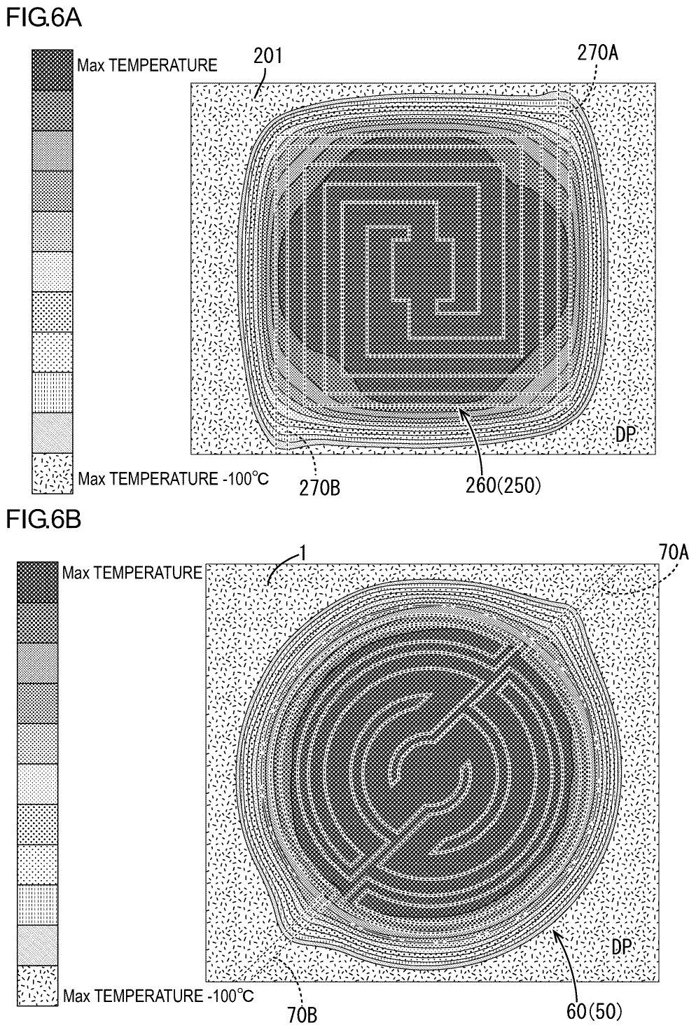

A thin film and a platinum layer were formed on a silicon substrate in the same manner as in the example, except that as shown in FIG. 5, a first lead portion 270A and a second lead portion 270B were placed, and a heat generating resistor 250 was placed so as to form a heater pattern 260 shown by a dashed line in FIG. 6A. Subsequently, an opening was formed in the back surface film 40 by etching, a through hole 211 was formed in a substrate 210, and the diaphragm DP was formed, in the same manner as the example, except that the shapes of the through hole, etc., were quadrangular tube shapes as shown in FIG. 5. The microheater 201 shown in FIG. 5 produced as described above was used as an evaluation sample of a comparative example.

### (Electricity-Heat Transfer Simulation)

The temperature distribution in the diaphragm DP was simulated when a voltage having the same magnitude was applied to each of the microheaters 1 and 201. FIG. 6A shows a temperature contour diagram obtained for the microheater 201 of the comparative example, and FIG. 6B shows a temperature contour diagram obtained for the microheater 1 of the example.

### (Evaluation Results)

As is obvious from the comparison between FIG. 6B and FIG. 6A, in the microheater 1 according to the example, the temperature distribution is less uneven as compared to that in the microheater 201 according to the comparative example, and the heat in the diaphragm DP is made uniform. In addition, when the average temperature of each heater was made equal, the difference between the highest and lowest temperatures calculated by simulation was 85.9° C. in the comparative example, while the difference was 39.7° C. in the example, which is half or less of that in the comparative example. It was confirmed that in the microheater 1, the heat uniformity was improved as compared to that in the microheater 201.

### <Effects regarding Microheater>

As described above, the microheater 1 according to the present embodiment includes the substrate 10 provided with the through hole 11 penetrating between the front surface 10F and the back surface 10B thereof, the thin film 30 placed on the front surface 10F so as to close the front surface 10F side of the through hole 11 and forming the diaphragm DP, the heat generating resistor 50 placed in the thin film 30 and configured to generate heat when power is supplied thereto, and the pair of lead portions 70A and 70B placed in the thin film 30 and configured to supply power to the heat generating resistor 50, the front surface-side opening 11F which is an opening on the front surface 10F side of the through hole 11 has a circular shape, the heat generating resistor 50 is placed such that the first virtual line VC1 connecting the outer circumference of the heat generating resistor 50 forms a circumference, the pair of lead portions 70A and 70B include the first lead portion 70A connected at the first connection portion 71A to the heat generating resistor 50 and the second lead portion 70B connected at the second connection portion 71B to the heat generating resistor 50, and the second connection portion 71B is located on the side opposite to the first connection portion 71A with respect to the reference diameter line RL orthogonal to the first radius RA connecting the first connection portion 71A and the placement center O which is the center of the first virtual line VC1.

In the above configuration, the heat generating resistor 50 is placed in a region having the same circular shape as the front surface-side opening 11F. Therefore, when the heat generating resistor 50 generates heat, the heat distribution in the diaphragm DP is made uniform as compared to that in a configuration in which the heat generating resistor is placed such that the outer edge of the heat generating resistor has a shape different from that of the opening edge of the front surface-side opening. In addition, since the front surface-side opening 11F has a circular shape in a plan view, stress acting on the thin film which forms the diaphragm DP is less likely to be concentrated on a specific portion as compared to that in a conventional configuration in which a through hole having a front surface-side opening having a quadrangular shape is provided. Furthermore, since the lead portions 70A and 70B which are temperature singularities are connected to the heat generating resistor 50 at positions separated from each other, the influence of the lead portions 70A and 70B on heat conduction can be distributed and reduced. As a result of these, damage to the thin film 30 due to thermal stress generated when the heat generating resistor 50 generates heat can be reduced, and deterioration due to stress migration can be mitigated, so that the microheater 1 having excellent durability can be obtained.

In the microheater 1 according to the present embodiment, the first lead portion 70A and the second lead portion 70B are provided outside the placement region where the heat generating resistor 50 is placed, so as to extend from the first connection portion 71A and the second connection portion 71B in opposite directions to each other.

In the above configuration, the first lead portion 70A and the second lead portion 70B are placed at positions separated from each other. Therefore, as compared to a configuration in which the lead portions 70A and 70B extend in the same direction, the influence of the heat generated in the lead portions 70A and 70B on the heat uniformity of the diaphragm DP can be suppressed.

In the microheater 1 according to the present embodiment, the placement center O coincides with the center of the front surface-side opening 11F when the substrate 10 is viewed in a plan view.

In the above configuration, the circular-shaped placement region of the heat generating resistor 50 and the front surface-side opening 11F which is also circular are concentric, and the distance from the outer edge of the heat generating resistor 50 to the opening edge of the front surface-side opening 11F is constant. Therefore, the heat conduction to the substrate 10 becomes uniform, and the heat uniformity in the diaphragm DP is improved. In addition, since the distance from the placement center O to the opening edge of the front surface 10F is constant, the anisotropy of stress acting on the thin film 30 which forms the diaphragm DP can be expected to be further reduced.

In the microheater 1 according to the present embodiment, the heat generating resistor 50 is placed so as to form the continuous heater pattern 60 connecting the first connection portion 71A and the second connection portion 71B with a single stroke, the pair of lead portions 70A and 70B extend straight so as to be point-symmetrical to each other about the placement center 0, and the heater pattern 60 includes the linear center portion 63 passing through the placement center O along the direction D70 in which the pair of lead portions 70A and 70B extend, the plurality of arc-shaped portions 65 extending on the plurality of virtual circumferences VC concentric with the first virtual line VC1, and the straight portion 67 connecting one end portion of one arc-shaped portion 65 and one end portion of another arc-shaped portion 65 in a straight manner. The first connection portion 71A and the second connection portion 71B are respectively provided at end portions of the two outermost circumference semi-circular arc-shaped portions 65-1 located on the outermost circumference and having a semi-circular arc shape among the plurality of arc-shaped portions 65, and the center portion 63 is connected to end portions of the two innermost circumference arc-shaped portions 65-O located on the innermost circumference among the plurality of arc-shaped portions 65.

In the above configuration, the heater pattern 60 can be formed such that the placement region of the heat generating resistor 50 has a perfectly circular shape and the distance from the plurality of arc-shaped portions 65 to the placement center 0 is constant. Therefore, the anisotropy of the heat distribution is reduced as compared to, for example, that in a configuration in which the heater pattern is formed in a spiral shape and the placement region has an elliptical shape. In addition, while the curvature of the wiring pattern needs to be changed steplessly in the spiral heater pattern, the curvature and radius at each arc-shaped portion 65 can be constant in this configuration, which facilitates placement design and allows dimensional inspection, etc., of a finished product to be easily performed.

In the microheater 1 according to the present embodiment, the heater pattern 60 has the plurality of straight portions 67, and includes: the first pattern 61 which forms one outermost circumference semi-circular arc-shaped portion 65-1 along the first virtual line VC1 from the first connection portion 71A, folds back via the straight portion 67-1 before the second connection portion 71B, forms the arc-shaped portion 65-2 along the virtual circumference VC2, folds back via the straight portion 67-2 on the second virtual line VL2A, which is an extension line of the first lead portion 70A, and is then connected to the protrusion portion 63A which is one end portion of the center portion 63; and the second pattern 62 which forms the other outermost circumference semi-circular arc-shaped portion 65-1 along the first virtual line VC1 from the second connection portion 71B, folds back via the straight portion 67-1 before the first connection portion 71A, forms the arc-shaped portion 65-2 along the virtual circumference VC2, folds back via the straight portion 67-2 on the second virtual line VL2B, which is an extension line of the second lead portion 70B, and is then connected to the protrusion portion 63B which is another end portion of the center portion 63.

The first pattern 61 may be configured to fold back via the straight portion 67-1, then form the arc-shaped portion 65-2 along the virtual circumference VC2, and be connected to the protrusion portion 63A of the center portion 63 on the second virtual line VL2A. The second pattern 62 may also be configured to form the arc-shaped portion 65-2 and be connected to the protrusion portion 63B of the center portion 63 on the second virtual line VL2B. In such a configuration, the heat generating resistor can be placed such that the anisotropy is reduced while the heater pattern has a relatively simple shape.

The first pattern 61 according to the present embodiment folds back via the straight portion 67-2 on the second virtual line VL2A, which is an extension line of the first lead portion 70A, then further forms the arc-shaped portion 65-3 along the virtual circumference VC3, folds back via the straight portion 67-3 before the second virtual line VL2B, which is an extension line of the second lead portion 70B, forms the arc-shaped portion 65-4 along the virtual circumference VC4, and is connected to the protrusion portion 63A, which is one end portion of the center portion 63, on the second virtual line VL2A. The same applies to the second pattern 62. That is, the first pattern 61 repeatedly folds back a predetermined number of times before the second virtual line VL2B or on the second virtual line VL2A, and connects the first connection portion 71A and the center portion 63. Meanwhile, the second pattern 62 can be configured to repeatedly fold back a predetermined number of times before the second virtual line VL2A or on the second virtual line VL2B, and connect the second connection portion 71B and the center portion 63. The first pattern 61 is folded back before the second virtual line VL2B, which is an extension line of the second lead portion 70B, upon odd-numbered folding, and is folded back on the second virtual line VL2A, which is an extension line of the first lead portion 70A, upon even-numbered folding. By changing the numbers of folds of the first pattern 61 and the second pattern 62, the heat distribution in the diaphragm DP can be adjusted according to the target set temperature of the microheater 1, etc.

When the heater pattern 60 is formed as described above, it is preferable that the number of folds in the first pattern 61 and the number of folds in the second pattern 62, that is, the numbers of arc-shaped portions 65 included in the respective patterns, are equal to each other. In addition, it is preferable that in the first pattern 61 or the second pattern 62, the arc-shaped portions 65 formed after being folded back the same number of times from the outermost circumference semi-circular arc-shaped portion 65-1 are formed on the same virtual circumference VC. With this configuration, the imbalance between the heat distribution in the first pattern 61 and the heat distribution in the second pattern 62 can be reduced.

In the microheater 1 according to the present embodiment, the heater pattern 60 is formed such that among the plurality of arc-shaped portions 65, the arc-shaped portion 65 closer to the placement center O has a larger wiring width W65.

In this configuration, the amount of heat generated per unit area by the heat generating resistor 50 is smaller in a central portion of the wiring region than in a peripheral portion of the wiring region. When the amount of heat generated per unit area in the wiring region is constant, the temperature of the central portion tends to be higher. However, when the amount of heat generated per unit area in the central portion is smaller than that in the peripheral portion, a rise in the temperature of the central portion is suppressed, so that the heat uniformity is improved. In the case where the heater pattern 60 has the plurality of straight portions 67 as in the present embodiment, it is preferable that the straight portions 67 are also formed such that the straight portion 67 closer to the placement center has a larger wiring width W67. It is also preferable that the wiring width W63 at the center portion 63 of the heater pattern 60 is larger. With this configuration, a rise in the temperature of the central portion of the wiring region is further suppressed, so that the heat uniformity is improved.

In the microheater 1 according to the present embodiment, each of the pair of second virtual lines VL2A and VL2B obtained by extending the pair of lead portions 70A and 70B, respectively, toward the inside of the placement region where the heat generating resistor 50 is placed passes through the center portion 63.

The pair of second virtual lines VL2A and VL2B obtained by extending the pair of lead portions 70A and 70B which are provided in a straight manner so as to be point-symmetrical with each other about the placement center 0 are parallel to each other. In the case where the pair of lead portions 70A and 70B are provided so as to extend on the same straight line, that is, on a diameter line passing through the placement center, if the wiring width W63 of the center portion 63 in the heater pattern 60 is to be increased, a region where the heat generating resistor 50 is not placed is formed in the vicinities of the first connection portion 71A, the second connection portion 71B, the straight portion 67 (folded portion of the arc-shaped portion 65), etc. When the lead portions 70A and 70B are shifted from each other and provided so as to extend on the pair of second virtual lines VL2A and VL2B which pass through the center portion 63, the wiring width W63 of the center portion 63 can be ensured without increasing the region where the heat generating resistor 50 is not placed, so that the heat uniformity can be improved.

In the microheater 1 according to the present embodiment, the heater pattern 60 is formed so as to be point-symmetrical about the placement center 0.

In this configuration, since the entire heater pattern 60 is point-symmetrical about the placement center 0, the anisotropy of the heat distribution is further reduced, so that the heat uniformity in the diaphragm DP is improved.

### <Gas Sensor>

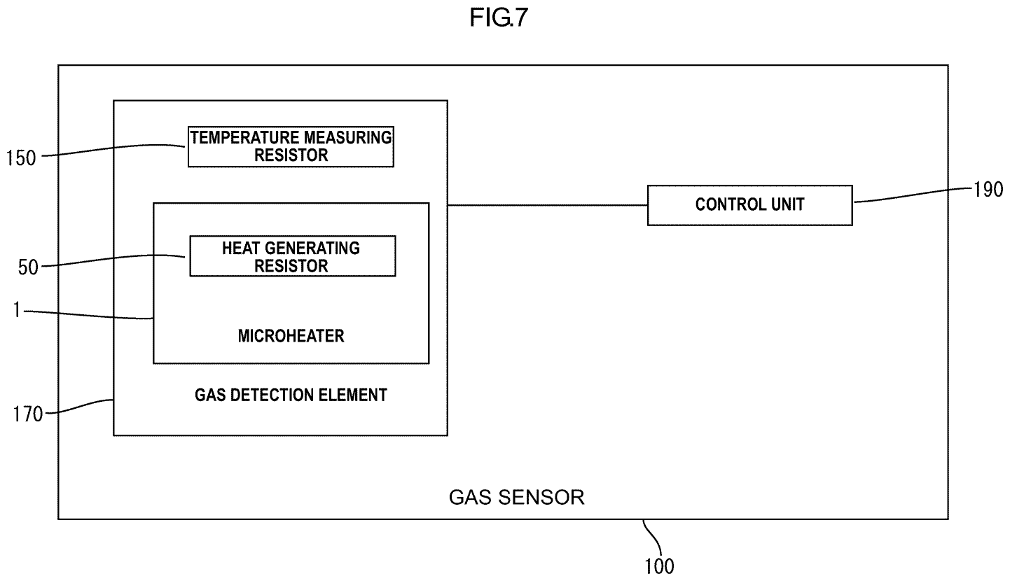

The microheater 1 according to the present embodiment described above can be used, for example, in a gas sensor 100. Here, the gas sensor 100 which is of a thermal conduction type for detecting a to-be-detected gas having a high thermal conductivity, such as combustible hydrogen gas contained in a to-be-detected atmosphere, will be described as an example. As shown in FIG. 7, the gas sensor 100 includes, for example, the gas detection element 170 including the microheater 1 described above, and a control unit 190. In addition to the microheater 1 including the heat generating resistor 50 placed so as to form the heater pattern 60, the gas detection element 170 has the temperature measuring resistor 150.

### (Temperature Measuring Resistor)

The temperature measuring resistor 150 is used to detect the temperature of a to-be-detected atmosphere (containing a to-be-detected gas) in a space in which the microheater 1 is installed. The temperature measuring resistor 150 is formed from a conductive material whose resistance value changes in proportion to the own temperature thereof, and can be placed, for example, in a region outside the portion, forming the diaphragm DP, in the thin film 30 of the microheater 1. The temperature measuring resistor 150 can be placed in the same layer as the heat generating resistor 50 (e.g., the third insulating layer 33 which forms the intermediate layer of the thin film 30) using a material including the same metal as in the heat generating resistor 50 (e.g., platinum). In this case, similar to the heat generating resistor 50, the temperature measuring resistor 150 is connected at one end portion thereof to an electrode connected to an external power supply, and at another end portion thereof to a ground electrode, via contact holes or the like formed in the insulating layers of the thin film 30.

### (Gas Detection Element)

In the gas detection element 170, when the heat generating resistor 50 generates heat due to temperature change (heat generation), heat conduction to the to-be-detected gas occurs. The amount of heat lost from the heat generating resistor 50 due to the heat conduction to the to-be-detected gas is determined depending on the concentration of the to-be-detected gas. Since the resistance values of the heat generating resistor 50 and the temperature measuring resistor 150 change due to the own temperatures thereof, the concentration of the to-be-detected gas can be detected on the basis of the changes in these resistance values.

### (Control Unit)

The control unit 190 drives and controls the gas detection element 170, and is composed of, for example, a microcomputer. In the control unit 190, the temperature of the to-be-detected gas is calculated on the basis of the change in the resistance value of the temperature measuring resistor 150. In addition, in the control unit 190, a voltage applied to the heat generating resistor 50 is adjusted according to the detected temperature, and the concentration of the to-be-detected gas contained in the to-be-detected atmosphere is calculated on the basis of the change in the resistance value of the heat generating resistor 50.

### <Effects regarding Gas Sensor>

As described above, the gas sensor 100 according to the present embodiment includes the microheater 1 according to the present disclosure.

In the above configuration, the microheater 1 having high heat uniformity and excellent durability is included, so that the gas sensor 100 capable of maintaining detection accuracy over a long period of time can be obtained. The microheater according to the present disclosure can be suitably applied to a thermal conduction type gas sensor, for example.

### <Other Embodiments>

(1) The materials forming the respective members in the microheater 1 and the gas sensor 100 of the above embodiment are merely an example, and each member may be formed from another material. For example, the film configuration of the thin film 30, the materials forming the heat generating resistor 50 and the lead portions 70A and 70B, etc., can be changed in various ways. In addition, the production method for the microheater 1 described in the above embodiment is merely an example, and is not limited thereto, and the microheater 1 according to the present disclosure can be produced using various known methods.

(2) In the above embodiment, the thermal conduction type gas sensor 100 has been described, but the microheater 1 can also be applied to gas sensors based on other measurement principles, other sensors, etc.

### Explanation of Symbols

1, 201: microheater
10, 210: substrate
10B: back surface
10F: front surface
11, 211: through hole
11B: back surface-side opening
11F: front surface-side opening
30: thin film
31: first insulating layer
32: second insulating layer
33: third insulating layer
34: fourth insulating layer
40: back surface film
41: first back surface insulating layer
42: second back surface insulating layer
50, 250: heat generating resistor
60, 260: heater pattern
61: first pattern
62: second pattern
63: center portion
63A, 63B: protrusion portion
63C: center circle portion
65: arc-shaped portion
65-1: outermost circumference semi-circular arc-shaped portion
65-O: innermost circumference arc-shaped portion
67: straight portion
70A, 270A: first lead portion
70B, 270B: second lead portion
71A: first connection portion
71B: second connection portion
100: gas sensor
150: temperature measuring resistor
170: gas detection element
190: control unit
D70: direction in which lead portions extend
DL: diagonal line
DP: diaphragm
O: placement center
RA: first radius
RL: reference diameter line
VC1: first virtual line
VC: virtual circumference
VCO: innermost virtual circumference
VL2A, VL2B: second virtual line
W: wiring width

What is claimed is:

1. A microheater comprising:
a substrate provided with a through hole penetrating between a front surface and a back surface thereof;
a thin film placed on the front surface so as to close the front surface side of the through hole and forming a diaphragm;
a heat generating resistor placed in the thin film and configured to generate heat when power is supplied thereto; and
a pair of lead portions placed in the thin film and configured to supply power to the heat generating resistor, wherein
a front surface-side opening which is an opening on the front surface side of the through hole has a circular shape,
the heat generating resistor is placed such that a first virtual line connecting an outer circumference of the heat generating resistor forms a circumference,
the pair of lead portions include
a first lead portion connected to a first connection portion provided at the heat generating resistor, and
a second lead portion connected to a second connection portion provided at the heat generating resistor, and
the second connection portion is located on a side opposite to the first connection portion with respect to a reference diameter line orthogonal to a first radius connecting the first connection portion and a placement center which is a center of the first virtual line.

2. The microheater according to claim 1, wherein the first lead portion and the second lead portion are provided outside a placement region where the heat generating resistor is placed, so as to extend from the first connection portion and the second connection portion in opposite directions to each other.

3. The microheater according to claim 1 wherein the placement center coincides with a center of the front surface-side opening when the substrate is viewed in a plan view.

4. The microheater according to claim 1, wherein
the heat generating resistor is placed so as to form a continuous heater pattern connecting the first connection portion and the second connection portion with a single stroke,
the pair of lead portions extend straight so as to be point-symmetrical to each other about the placement center,
the heater pattern includes
a linear center portion passing through the placement center along a direction in which the pair of lead portions extend,
a plurality of arc-shaped portions extending on a plurality of virtual circumferences concentric with the first virtual line, and
a straight portion connecting one end portion of one of the arc-shaped portions and one end portion of another of the arc-shaped portions in a straight manner,
the first connection portion and the second connection portion are respectively provided at end portions of two outermost circumference semi-circular arc-shaped portions located on an outermost circumference and having a semi-circular arc shape among the plurality of arc-shaped portions, and
the center portion is connected to end portions of two innermost circumference arc-shaped portions located at an innermost circumference among the plurality of arc-shaped portions.

5. The microheater according to claim 4, wherein the heater pattern has a plurality of the straight portions, and includes
a first pattern which forms one of the outermost circumference semi-circular arc-shaped portions along the first virtual line from the first connection portion, folds back via the straight portion before the second connection portion, forms the arc-shaped portion along the virtual circumference, and is connected to one end portion of the center portion on an extension line of the first lead portion, and
a second pattern which forms another of the outermost circumference semi-circular arc-shaped portions along the first virtual line from the second connection portion, folds back via the straight portion before the first connection portion, forms the arc-shaped portion along the virtual circumference, and is connected to another end portion of the center portion on an extension line of the second lead portion.

6. The microheater according to claim 4, wherein the heater pattern has a plurality of the straight portions, and includes
a first pattern which forms one of the outermost circumference semi-circular arc-shaped portions along the first virtual line from the first connection portion, folds back via the straight portion before the second connection portion, forms the arc-shaped portion along the virtual circumference, folds back via the straight portion on an extension line of the first lead portion, and is then connected to one end portion of the center portion, and
a second pattern which forms another of the outermost circumference semi-circular arc-shaped portions along the first virtual line from the second connection portion, folds back via the straight portion before the first connection portion, forms the arc-shaped portion along the virtual circumference, folds back via the straight portion on an extension line of the second lead portion, and is connected to another end portion of the center portion.

7. The microheater according to claim 4, wherein the heater pattern is formed such that among the plurality of arc-shaped portions, the arc-shaped portion closer to the placement center has a larger wiring width.

8. The microheater according to claim 4, wherein each of a pair of second virtual lines obtained by extending the pair of lead portions, respectively, toward an inside of a placement region where the heat generating resistor is placed passes through the center portion.

9. The microheater according to claim 4, wherein the heater pattern is formed so as to be point-symmetrical about the placement center.

10. A gas sensor comprising the microheater according to claim 1.
